(19) United States
(12) Patent Application Publication
(10) Pub. No.: US 2020/0111055 A1
(43) Pub. Date: Apr. 9, 2020

(54) METHOD OF DEVELOPING AN INCUBATOR PROGRAM TO GROW TECHNOLOGY COMPANIES

(71) Applicant: DUNHILL TECHNOLOGY PARTNERS, LLC, MALTA, NY (US)

(72) Inventors: Timothy F. DUNN, Malta, NY (US); LaMar A. HILL, Scotia, NY (US)

(73) Assignee: DUNHILL TECHNOLOGY PARTNERS, LLC, MALTA, NY (US)

(21) Appl. No.: 16/593,475

(22) Filed: Oct. 4, 2019

Related U.S. Application Data
(60) Provisional application No. 62/741,186, filed on Oct. 4, 2018.

(51) Int. Cl. G06Q 10/10; G06Q 50/18; G06Q 50/20

(52) U.S. Cl. CPC G06Q 10/101; G06Q 50/184; G06F 17/505; G06Q 50/2053; G06Q 50/2057

(57) ABSTRACT

A method of developing an incubator program includes establishing an accelerator organization having tier 1 members and tier 2 members. A suite of EDA tools is licensed or purchased by the organization. The tier 1 members are charged a first fee. The tier 2 members are charged a second smaller fee. The tier 2 members obtain full access to the EDA tools. Tier 2 intellectual property rights are developed through the use of the EDA tools by the tier 2 members. The tier 1 members are provided a first right to offer to acquire or license the tier 2 intellectual property rights from the tier 2 members for a predetermined period of time. The tier 2 members are required not offer to assign or license tier 2 intellectual property to anyone other than a tier 1 member prior to a tier 1 member's exercise of its first right to offer.

### CROSS-REFERENCE TO RELATED APPLICATIONS

This Patent Application claims priority to U.S. Provisional Patent Application No. 62/741,186, filed Oct. 4, 2018, and entitled A METHOD OF DEVELOPING AN INCUBATOR PROGRAM TO GROW TECHNOLOGY COMPANIES. The entire contents of the aforementioned application is hereby incorporated herein by reference.

### BACKGROUND

Electronic Design Automation (EDA) tools, also referred to as electronic computer-aided design (ECAD) tools, are a category of software tools for designing electronic systems such as integrated circuits (IC) and printed circuit boards. The tools work together in a design flow that chip designers use to design and analyze entire semiconductor chips. Since a modern semiconductor chip can have billions of components, EDA tools are essential for their design.

However, such EDA tools are expensive. To purchase a full suite of EDA tools that would enable an engineering design team to design, fabricate and test a new computer chip may cost a company several million dollars or more. This is a significant purchase even for a large company.

Additionally, the time to develop a new IC chip, from design phase to production, is also significant in that it may take a number of years. Moreover, the company designing the IC chip may not know if their new idea will sell in the target market and produce enough revenue to justify the expense of developing the idea for many years.

These barriers to entry into the IC design and manufacturing industry are high for small to medium sized companies and even for companies with revenue in the hundreds of millions of dollars per year. These barriers also tend to suppress the development of innovative concepts in even larger companies.

Accordingly, there is a need for reducing these barriers to entry in the IC design and manufacturing industry. Further, there is a need to make these EDA tools more accessible to small companies and entrepreneurs. Additionally, there is a need to further incentivize innovation in the IC industry.

### BRIEF DESCRIPTION

The present disclosure offers advantages and alternatives over the prior art by providing a method of developing an incubator program for small companies and entrepreneurs that have a need for utilizing EDA tools to develop inventive concepts. The method reduces barriers to entry in the IC design and manufacturing industry. Further, the method makes EDA tools more accessible to small companies and entrepreneurs. Additionally, the method further incentivizes innovation in the IC industry.

A method of developing an incubator program in accordance with one or more aspects of the present disclosure includes establishing an accelerator organization having a tiered membership, including at least tier 1 members and tier 2 members. A suite of EDA tools is licensed by the organization from EDA tool suppliers. The tier 1 members are charged a first fee payable to the organization. The tier 2 members are charged a second fee payable to the organization. The second fee is significantly smaller than the first fee. The tier 2 members obtain full access to the EDA tools. Tier 2 intellectual property rights are developed through the use of the EDA tools by the tier 2 members. The tier 1 members are provided a first right to offer to acquire or license a first portion of the tier 2 intellectual property rights from the tier 2 members for a predetermined period of time. The tier 2 members are required not offer to assign or license the first portion of tier 2 intellectual property to anyone other than a tier 1 member prior to a tier 1 member's exercise of its first right to offer.

### DRAWINGS

The disclosure will be more fully understood from the following detailed description taken in conjunction with the accompanying drawings, in which:

FIG. 1A depicts an example of a first portion of an EDA design flow enabled by various EDA tools to develop various technical concepts according to aspects described herein;

FIG. 1B depicts an example of a second portion of the EDA design flow of FIG. 1A according to aspects described herein;

FIG. 2 depicts an example of a method of developing an incubator program wherein an accelerator organization is established having tiered membership, the membership utilizing EDA tools provided by the accelerator organization to develop technical concepts for each other's mutual benefit according to aspects described herein;

FIG. 3 depicts an example of a method of further developing the incubator program of FIG. 2, wherein the accelerator organization includes academic partners according to aspects described herein; and

FIG. 4 depicts an example of a method of further developing the incubator program of FIGS. 2 and 3, wherein the academic partners includes at least one of a community college and a high school for purposes of work force development for the incubator program according to aspects described herein.

### DETAILED DESCRIPTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example may be combined with the features of other examples. Such modifications and variations are intended to be included within the scope of the present disclosure.

The terms “substantially”, “approximately”, “about”, “relatively,” or other such similar terms that may be used throughout this disclosure, including the claims, are used to describe and account for small fluctuations, such as due to variations in processing from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

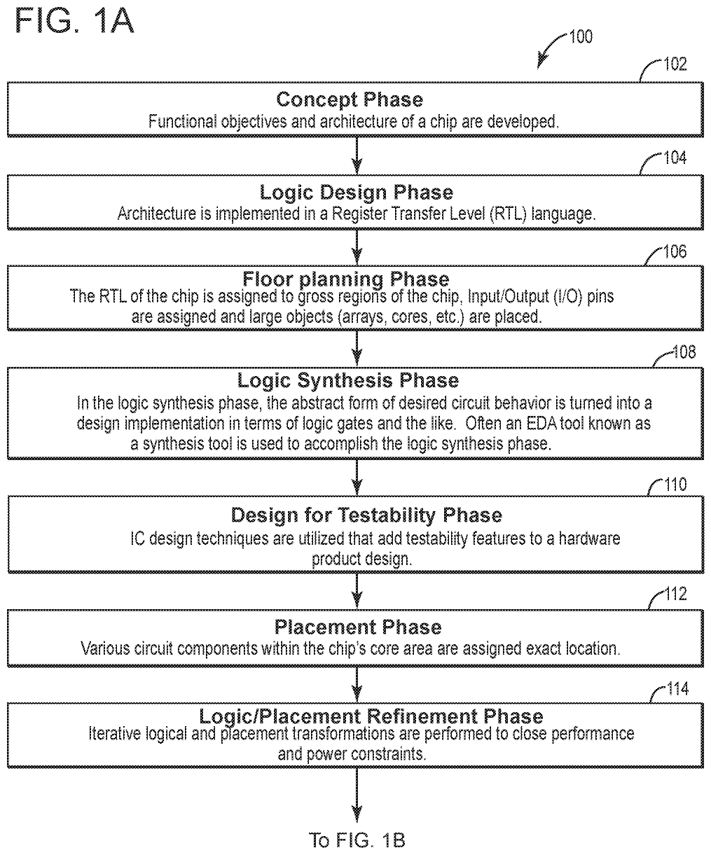

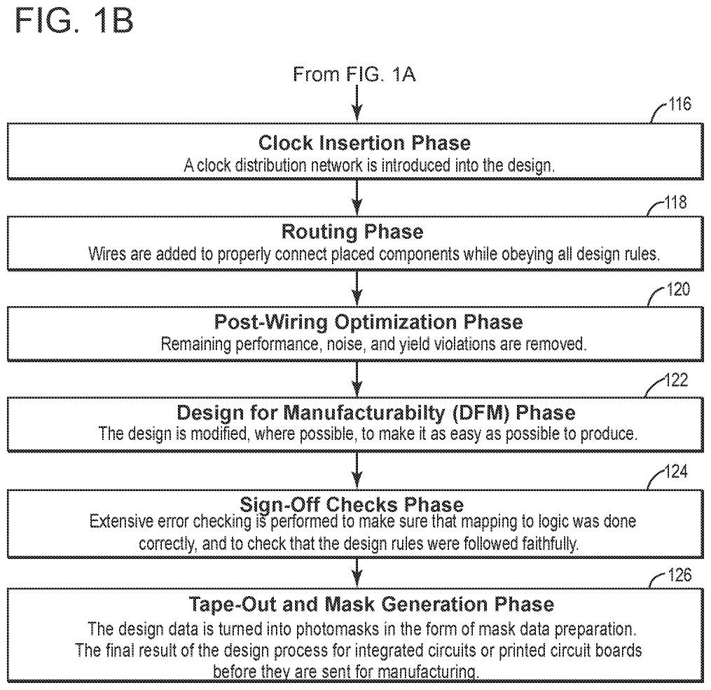

Referring to FIGS. 1A and 1B, an example of an Electronic Design Automation (EDA) design flow process 100 to develop various technical concepts according to aspects described herein is presented. More specifically, FIG. 1A illustrates the concept phase, logic design phase, floor planning phase, logic synthesis phase, design for testability phase, placement phase and logic/placement refinement phase of the example of the design flow process 100. Also more specifically, FIG. 1B illustrates the clock insertion phase, routing phase, post-wiring optimization phase, design for manufacturability phase, sign-off checks phase and tape-out and mask generation phase of the design flow process 100.

The process 100 utilizes one or more EDA tools, which are a category of software tools for designing electronic systems such as integrated circuits (IC) and printed circuit boards. The EDA tools work together to enable the design flow process 100 that chip designers use to design and analyze entire semiconductor chips with potentially billions of transistors.

The design flow process 100 begins with a concept phase 102. In the concept phase, functional objectives and architecture of a chip are developed.

The process continues to a logic design phase 104. In the logic phase, IC architecture is typically implemented in a register transfer level (RTL) language. It is then simulated to verify that it performs the desired functions.

The process continues to a floor planning phase 106. In the floor planning phase 106, the RTL of the chip is assigned to gross regions of the chip, input/output (I/O) pins are assigned and large objects (arrays, cores, etc.) are placed on the chip.

The process then continues to a logic synthesis phase 108. Logic synthesis is a process by which an abstract form of desired circuit behavior is turned into a design implementation in terms of logic gates and the like. Often an EDA tool known as a synthesis tool is used to accomplish the logic synthesis phase.

The process continues to the design for testability (DPT) phase 110. The DPT phase 110 includes IC design techniques that add testability features to a hardware product design. The added features make it easier to develop and apply manufacturing tests to the designed hardware. The purpose of manufacturing tests is to validate that the product hardware contains no manufacturing defects that could adversely affect the product's correct functioning.

The process continues to the placement phase 112. In the placement phase 112, various circuit components within the chip's core area are assigned exact location. Placement of the circuit components must adhere to a number of circuit design rules and optimize a number of circuit design objectives to ensure that a circuit meets its performance requirements. An improperly placed component may affect the chip's performance. Additionally, such an improperly placed component might make the chip non-manufacturable by producing excessive wire lengths that are beyond available wire routing resources.

The process continues to the logic/placement refinement phase 114. In the logic/placement refinement phase 114, iterative logical and placement transformations are preformed to close various performance and power constraints in the design of the circuit.

The process continues to the clock insertion phase 116. In the dock insertion phase 116, a clock distribution network is introduced into the design. The clock distribution network (sometimes known as a clock tree) distributes the clock signal(s) from a common point to all the elements that need it. Since this function is vital to the operation of a synchronous system, much attention has been given to the characteristics of these clock signals and the electrical networks used in their distribution.

The process continues to the routing phase 118. In the routing phase 118 (sometimes called the wire routing phase), wires are added to properly connect the placed components while obeying all design rules in a design rule set for the particular IC system being designed. Design rules are specific to a particular semiconductor manufacturing process. A design rule set specifies certain geometric and connectivity restrictions to ensure sufficient margins to account for variability in semiconductor manufacturing processes, so as to ensure that most of the parts work correctly.

The process continues to the post-wiring optimization phase 120. In the post-wiring optimization phase, remaining performance noise, and yield violations are removed.

The process continues to the design for manufacturability (DFM) phase 122. In the DFM phase 122, the design is modified, where possible, to make it as easy as possible to produce. DFM is the general engineering practice of designing products in such a way that they are easy to manufacture. DFM describes the process of designing or engineering a product in order to facilitate the manufacturing process in order to reduce its manufacturing costs. DFM will allow potential problems to be fixed in the design phase which is the least expensive place to address them. Other factors that may affect manufacturability, and may be addressed during the DFM phase, include the type of raw materials, the form of the raw materials, dimensional tolerances, and secondary processing such as finishing.

The process continues to the sign-off checks phase 124. Since errors are expensive, time consuming and hard to spot, extensive error checking is the rule, making sure the mapping to logic was done correctly, and checking that the design rules were followed faithfully.

In the EDA design flow process 100, the sign-off checks phase 124 is the collective name given to a series of verification steps that the design must pass before it can be taped out. This implies an iterative process involving incremental fixes across the board using one or more check types, and then retesting the design.

The process continues with the tape-out and mask generation phase 126. In tape-out and mask generation 126, the design data is turned into photomasks in the form of mask data. The tape-out and mask generation phase 126 is the final result of the design process for integrated circuits or printed circuit boards before they are sent for manufacturing. The tape-out is specifically the point at which the graphic for the photomask of the circuit is sent to the fabrication facility.

The various phases 102-126 of the EDA flow design process 100 exemplified in FIGS. 1A and 1B do not represent an exhaustive list of phases. Additionally, the phases may not occur in the order listed. Further the phases may be iterated several times before the design is ready for manufacturing.

The EDA flow design process 100 is done utilizing various EDA tools. Such EDA tools have become as essential to the design of modern day large scale integrated circuits as Microsoft Word ° has become to written compositions. That is, the design of a semiconductor chip with just a few million transistors would take many man years to complete without the aid of EDA tools. Additionally, more complex chips with billions of transistors, would be virtually impossible to design without utilizing such EDA tools.

However, such EDA tools are expensive. To purchase a full suite of EDA tools that would enable an engineering design team to design, fabricate and test a new computer chip may cost a company 2 to 3 million dollars or more. These costs may present significant barriers to small companies and entrepreneurs for entry into commercial markets with new and innovative IC designs.

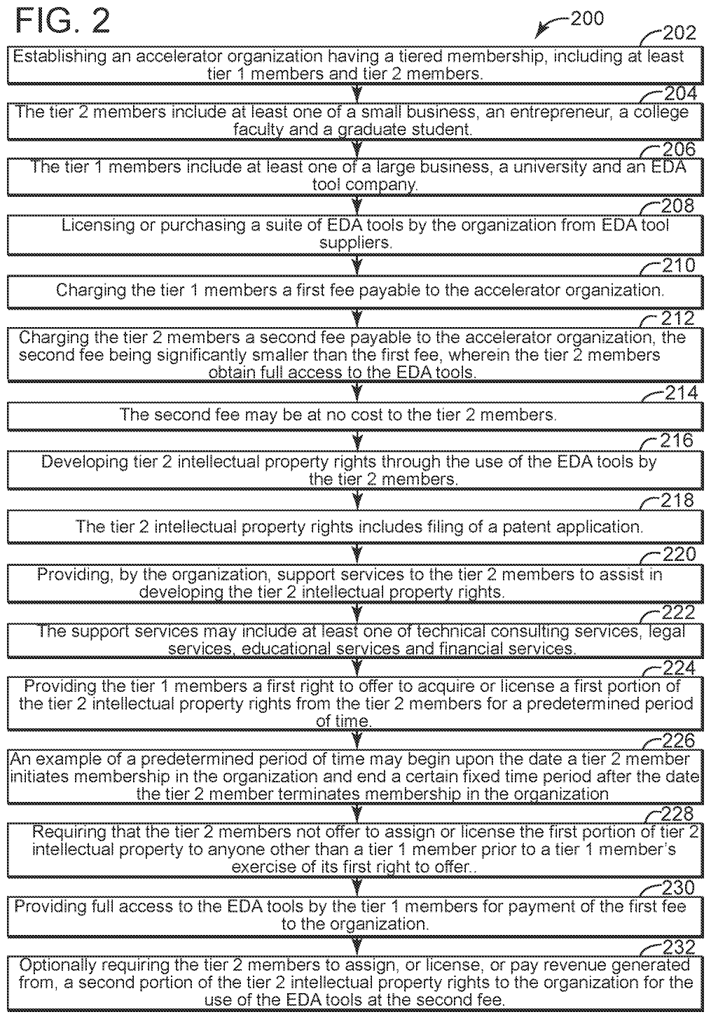

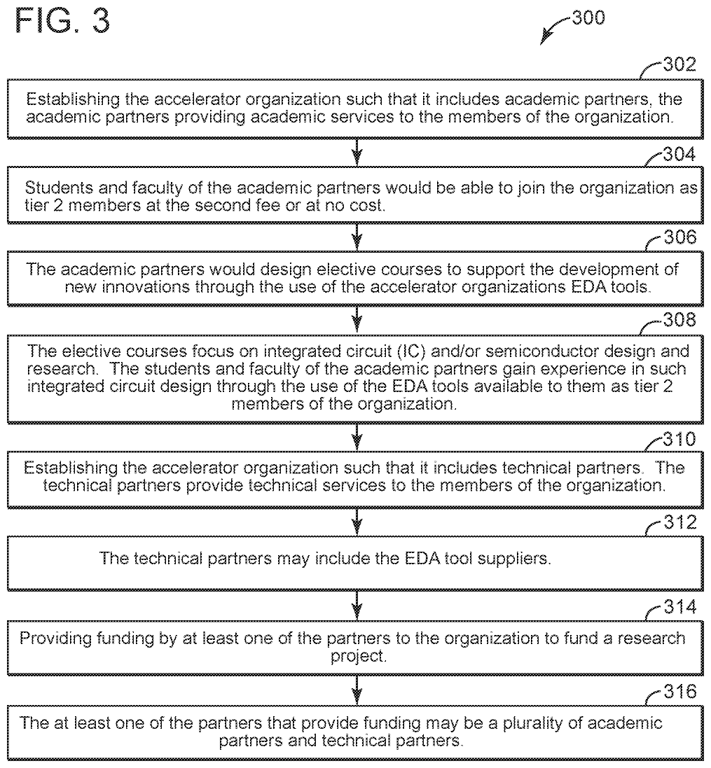

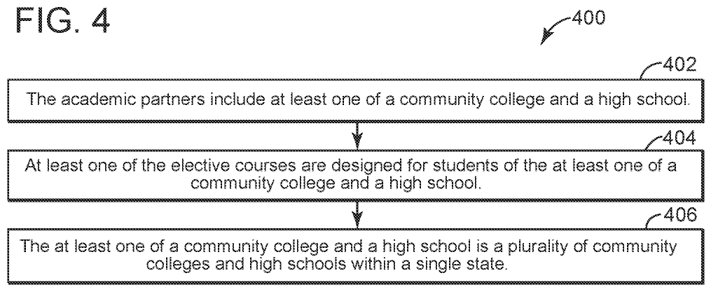

Accordingly, the following methods of developing an incubator program as exemplified in FIGS. 2, 3 and 4 may advantageously reduce those barriers. Broadly, the methods may include one or more of the following three main components:
Establishing an accelerator organization (or accelerator program or accelerator) within the incubator program for small businesses and entrepreneurs engaged in the development of IC innovations, an example of which is illustrated in FIG. 2. The Accelerator program having a tiered membership, wherein unique incentives are provided among the tiered members to encourage innovation and accelerate development time to market.
An academic partner support program associated with the accelerator organization, an example of which is illustrated in FIG. 3. The academic partners provide additional support for the accelerator's members and the accelerator organization provides benefits to the academic partners.
A work force development program for developing an experienced workforce for the accelerator program, an example of which is illustrated in FIG. 4. The work force development program utilizes incentives provided by the accelerator organization and the academic partners for encouraging the development of undergraduate or high school designers having hands-on experience in designing IC systems with the use of EDA tools.

Referring to FIG. 2, an example of a method 200 of developing an incubator program is depicted. The method includes establishing an accelerator organization having tiered membership. The membership utilizes EDA tools provided by the accelerator organization to develop technical concepts for each other's mutual benefit according to aspects described herein.

At 202, the method 200 begins with the establishment of an accelerator organization. The accelerator organization includes a tiered membership.

At 204 and 206, the method 200 includes the tiered membership having at least tier 1 members and tier 2 members. The tier 1 members include at least one of a large business, a university and an EDA tool company. The tier 2 members include at least one of a small business, an entrepreneur, a college faculty and a graduate student.

At 208, the method 200 includes licensing or purchasing a suite of EDA tools by the accelerator organization from one or more EDA tool suppliers. Examples of EDA tool suppliers would be:
Synopsis, Inc. of Mountain View, Calif., USA for logic synthesis tools, behavioral synthesis tools, place and route tools, static timing analysis tools, formal verification tools, hardware description language simulators, transistor-level circuit simulation tools and the like.
Cadence Design Systems of San Jose, Calif., USA for custom IC design technologies, digital and signoff technologies, system verification technologies, PCB and packaging technologies and the like.
Keysight Technologies of Santa Rosa, Calif., USA for electronic test and measurement equipment and software.

At 210, the tier 1 members are charged a first fee payable to the organization. As will be discussed in greater detail herein, the membership fee may provide access to the use of the EDA tools. However, the membership fee also advantageously provides a right of first offer for developed intellectual property by that of the tier 2 members.

At 212, the tier 2 members are charged a second fee payable to the organization, the second fee is significantly smaller than the first fee that is charged to the tier 1 members. The fee (or membership fee) enables the tier 2 members to obtain full access to the EDA tools for purposes of developing innovative concepts and tier 2 intellectual property.

At 214, the second fee may be not only be significantly less than the first fee charged to the tier 1 members, the second fee may be at no cost to the tier 2 members. However, as will be discussed in greater detail herein, a portion of the tier 2 intellectual property rights are made available to the tier 1 members in return for the tier 2 members accepting such a low second fee.

Though this method 200 illustrates only tier 1 and tier 2 members, it is within the scope of this disclosure to have additional tiers within the accelerator organization. For example the accelerator organization may choose to establish a category of tier 3 members. Such tier 3 members may include small to medium sized businesses for which paying for full access to a suite of EDA tools is still a significant barrier. Such tier 3 members may have the same or similar benefits and obligations as the tier 2 members, but may be charged a third fee that is less than the first fee charged to the tier 1 members and greater than the second fee charged to tier 2 members.

At 216, the tier 2 may develop various tier 2 intellectual property rights based on their innovative concepts. The tier 2 intellectual property rights are developed through the use of the EDA tools by the tier 2 members.

At 218, development of tier 2 intellectual property rights may include the filing of one or more patent applications based on the innovative concepts. These patent applications may include a provisional patent application or a non-provisional patent application. However, such tier 2 intellectual property rights may also include trade secrets, not yet filed patent applications, issued patents, design patents, trademarks, copyrights or the like.

At 220, the method 200 includes the organization providing support services to the tier 2 members. The support services are to assist the tier 2 members in developing the tier 2 intellectual property rights.

At 222, the support services may include at least one of technical consulting services, legal services, educational services and financial services. The support services may come from outside investors and/or partners, special members other than the tier 1 or tier 2 members, professional firms hired by the accelerator organization or the tier 1 members themselves.

At 224, the method 200 includes the tier 1 members being provided a first right to offer to acquire or license a first portion of the tier 2 intellectual property rights for a predetermined period of time. The first right would be one of the membership benefits that the tier 1 members obtain upon payment of the first fee. The first right may be for a partial portion of the tier 2 intellectual property rights or may be for the entire portion.

At 226, one example of the predetermined period of time that the first right to offer may be valid for, may begin upon the date a tier 2 member initiates membership in the organization and may end a certain fixed time period after the date the tier 2 member terminates membership in the organization. For example, the first right to offer may start upon the date that the tier 2 member joins the accelerator organization as a condition of the tier 2 member being given access to the organizations suite of EDA tools. The first right to offer may expire on the first anniversary of the tier 2 member leaving the organization.

This is only one example of the fixed time period for the first right to offer. A goal of the fixed time period may be to balance the needs of the tier 1 members to receive unique benefits for the higher first fee they pay to the accelerator organization, while not overly burdening the tier 2 member's needs to sell or license their tier 2 intellectual property rights if the tier 1 members take too long to exercise their first right to offer.

At 228, the method 200 may include requiring that the tier 2 members not offer to assign or license the first portion of tier 2 intellectual property to anyone other than a tier 1 member prior to a tier 1 member's exercise of its first right to offer. At 228, a tier 1 member's first right to offer is further protected by restricting the tier 2 members from licensing or selling their tier 2 intellectual property rights until the tier 1 members have had a reasonable time to exercise their first right to offer.

At 230, the method 200 may include an additional benefit to the tier 1 members of providing them full access to the EDA tools for payment of the first fee to the organization. The additional benefit may be optional.

At 232, the method 200 may require the tier 2 members to assign, license or provide revenue generated from a second portion of the tier 2 intellectual property rights to the accelerator organization for the use of the EDA tools at the second fee. This may be an additional condition imposed upon the tier 2 members for having access to the organizations suite of EDA tools at a cost substantially below market value and at no cost.

In this example of method 200, the first portion of the tier 2 intellectual property rights is transferred from a tier 2 member to a tier 1 member only after the tier 1 member exercises its first right to offer and the tier 2 member accepts that offer. The size and scope of that first portion would be determined by negotiations between the parties involved. The second portion of the tier 2 intellectual property rights may be an obligated transfer from a tier 2 member to the accelerator organization as a condition of membership at below market cost or zero cost. The size and scope of that second portion would be determined by the terms of the membership agreement.

For example, a tier 1 member may exercise its first right to offer by negotiating an exclusive license to operate the tier 2 intellectual property rights within a certain geometric territory that the tier 2 members may accept. However, the tier 2 member may be obligated to provide a non-exclusive, transferable license to the accelerator organization within a different geometric territory for the same intellectual property rights.

Also by way of another example, the tier 2 members may be obligated to pay a percentage of revenue (e.g., 1 to 5 percent) to the accelerator organization generated from any tier 2 intellectual property rights developed with the use of the EDA tools during their time of membership and later filed as a patent application within two years after the termination of their membership. This obligation to pay the accelerator organization a percentage of revenue may be transferred to a tier 1 member if the tier 1 member exercises its right of first offer to acquire or license the rights to the entire remaining tier 2 intellectual property rights.

As an overview, the foregoing example of method 200 includes the establishment of an accelerator organization that purchases or licenses a suite of EDA tools. The accelerator has a tiered membership having at least tier 1 and tier 2 members. The tier 1 members are charged a first membership fee. The tier 2 members are charged a substantially smaller second membership fee or no fee at all. Advantageously, full access to the EDA tools are provided to tier 2 members of the accelerator organization in order to encourage innovation of certain IC concepts by the tier 2 members and the development of certain tier 2 intellectual property rights. Uniquely, in exchange for such low cost access to the EDA tools, the tier 2 members agree to give the tier 1 members a first right to offer to acquire or license a first portion of the tier 2 intellectual property rights for a predetermined amount of time. Additionally, the tier 2 members may also be required, as a condition of their low cost membership, to provide a second portion of the tier 2 intellectual property rights to the accelerator organization.

Referring to FIG. 3, an example of a method 300 of further developing the incubator program of FIG. 2 is depicted. In FIG. 3 the accelerator organization also includes academic partners. The academic partners provide additional support for members of the accelerator organization and the accelerator organization provides benefits to the academic partners.

At 302, the method 300 complements the method illustrated in FIG. 2 by establishing the accelerator organization such that it includes academic partners. The academic partners may include colleges, universities and other like institutions of higher education that provide undergraduate and graduate degree programs related to IC and semiconductor manufacturing.

The academic partners would provide academic services to the members of the organization, such as the tier 2 and tier 1 members. For example, the academic partners may provide resources for joint research programs that some tier 1 members might be interested in funding and that tier 2 members could help develop through the use of the accelerator's suite of EDA tools.

At 304, in return for the academic services provided to the members, students and faculty of the academic partners may be able to join the organization as tier 2 members at the same second fee as other tier 2 members or at no cost. Accordingly, those students and faculty members would have full access to the suit of EDA tools that they could utilize to enhance research sponsored by the academic partners. Alternatively, such students or faculty may utilize to EDA tools for their own personal research projects not related to the activities of their associated academic partner.

At 306, the academic partners may design elective courses to support the development of new innovations through the use of the accelerator organization's EDA tools. More specifically, the elective courses may provide additional hands-on experience for tier 2 members in the use of the accelerator's EDA tools in order to further enhance innovations being developed by the tier 2 members within the accelerator organization.

At 308, the elective courses may focus on integrated circuit (IC) and semiconductor design and research. As such, the students and faculty of the academic partners would gain experience in such integrated circuit design through the use of the EDA tools available to them as tier 2 members of the accelerator organization.

At 310, the method 300 may also include establishing the accelerator organization such that it includes technical partners. The technical partners may be other large companies involved in IC and semiconductor systems design. The technical partners may or may not also be tier 1 members. The technical partners would provide technical services to the members (e.g., tier 1 and tier 2 members) of the organization.

At 312, the technical partners may include the EDA tool suppliers. As such, the technical services may include the EDA tool suppliers working with the academic partners to design elective courses that focus on IC design through the use of the specific EDA tools provided by the EDA tool suppliers.

At 314, at least one of the partners may also provide funding to the accelerator organization to fund a research project. The research project may be performed by the members in a certain topic that the funding partner is interested in. Moreover, at 316, a plurality of academic partners and technical partners, rather than just one partner, may be interested in funding such a research project.

Referring to FIG. 4, an example is depicted of a method 400 of further developing the incubator program of FIGS. 2 and 3, wherein the academic partners includes at least one of a community college and a high school for purposes of developing a work force for the incubator program (i.e., a work force development program) according to aspects described herein. The method 400 utilizes incentives provided by the accelerator organization and the academic partners for encouraging the development of a work force of undergraduate or high school students having hands-on experience in designing IC systems with the use of the accelerator organization's EDA tools.

At 402, the method 400 complements the method illustrated in FIGS. 2 and 3 by establishing the accelerator organization such that it's academic partners also include at least one of a community college and a high school. Preferably there would be several community colleges and/or high schools included as academic partners. As an academic partner, the students and faculty of these community colleges and high schools would enjoy the same privileges as any tier 2 member in the accelerator program.

At 404, the method 400 would continue, wherein at least one of the elective courses designed by the academic partners are designed for students of at the community college and/or high school level. More specifically they would be designed for students of the at least one of a community college and a high school that is an academic partner. Preferably, there would be several such courses developed. The elective courses may be designed to provide hands-on experience for community college and high school students in the use of the accelerator's EDA tools in order to develop a growing work force of future innovators within the accelerator organization.

At 406, the method would continue, wherein the at least one of a community college and a high school is a plurality of community colleges and high schools within a single state. It would be advantageous to develop the growing work force within a geographic area that is reasonably proximate to the physical location of the accelerator organization. One such way of doing this is to focus on providing such elective courses to community colleges and high schools within a specific state. As such, many state government funds may be available to further enhance the overall goals of the incubator program and its accelerator organization.

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Although the invention has been described by reference to specific examples, it should be understood that numerous changes may be made within the spirit and scope of the inventive concepts described. Accordingly, it is intended that the disclosure not be limited to the described examples, but that it have the full scope defined by the language of the following claims.

What is claimed is:

1. A method of developing an incubator program, the method comprising:
establishing an accelerator organization having a tiered membership, including at least tier 1 members and tier 2 members;
at least one of purchasing and licensing a suite of EDA tools by the organization from EDA tool suppliers;
charging the tier 1 members a first fee payable to the organization;
charging the tier 2 members a second fee payable to the organization, the second fee being significantly smaller than the first fee, wherein the tier 2 members obtain full access to the EDA tools;
developing tier 2 intellectual property rights through the use of the EDA tools by the tier 2 members;
providing the tier 1 members a first right to offer one of acquiring and licensing a first portion of the tier 2 intellectual property rights from the tier 2 members for a predetermined period of time, and
requiring that the tier 2 members not offer to assign or license the first portion of tier 2 intellectual property to anyone other than a tier 1 member prior to a tier 1 member's exercise of its first right to offer.

2. The method of claim 1, comprising:
requiring the tier 2 members to one of assign, license, and provide revenue generated from, a second portion of the tier 2 intellectual property rights to the organization for the use of the EDA tools at the second fee.

3. The method of claim 1, wherein the second fee is at no cost to the tier 2 members.

4. The method of claim 1, comprising:
providing full access to the EDA tools by the tier 1 members for payment of the first fee to the organization.

5. The method of claim 1, wherein the tier 2 members include at least one of a small business, an entrepreneur, a college faculty and a graduate student.

6. The method of claim 1, wherein the tier 1 members include at least one of a large business, a university and an EDA tool company.

7. The method of claim 1, wherein developing of tier 2 intellectual property rights includes filing of a patent application.

8. The method of claim 1, wherein the predetermined period of time begins upon the date a tier 2 member initiates membership in the organization and ends a certain fixed time period after the date the tier 2 member terminates membership in the organization.

9. The method of claim 1, comprising providing, by the organization, support services to the tier 2 members to assist in developing the tier 2 intellectual property rights.

10. The method of claim 9, wherein the support services include at least one of technical consulting services, legal services, educational services and financial services.

11. The method of claim 1 comprising establishing the organization such that it includes academic partners, the academic partners providing academic services to the members of the organization.

12. The method of claim 11, wherein:
students and faculty of the academic partners would be able to join the organization as tier 2 members at no cost; and
the academic partners would design elective courses to support the development of new innovations through the use of the organizations EDA tools.

13. The method of claim 12, wherein the elective courses focus on integrated circuit (IC) design, and wherein the students and faculty of the academic partners gain experience in such integrated circuit design through the use of the EDA tools available to them as tier 2 members of the organization.

14. The method of claim 13 comprising establishing the organization such that it includes technical partners, the technical partners providing technical services to the members of the organization.

15. The method of claim 14, wherein the technical partners include the EDA tool suppliers, and wherein the technical services include the EDA tool suppliers working with the academic partners to design the elective courses such that they focus on IC design through the use of the EDA tools provided by the EDA tool suppliers.

16. The method of claim 15 comprising providing funding by at least one of the partners to the organization to fund a research project by the members in a certain topic that the at least one of the partners is interested in.

17. The method of claim 16 wherein the at least one of the partners is a plurality of academic partners and technical partners.

18. The method of claim 17 wherein the academic partners include at least one of a community college and a high school.

19. The method of claim 18, wherein at least one of the elective courses are designed for students of the at least one of a community college and a high school.

20. The method of claim 19, wherein the at least one of a community college and a high school is a plurality of community colleges and high schools within a single state.
